(19) United States
(12) Patent Application Publication
(10) Pub. No.: US 2021/0153580 A1
(43) Pub. Date: May 27, 2021

(54) PUNCTURE-PROOF STRUCTURE

(71) Applicant: HOCHENG CORPORATION, PA-TE CITY (TW)

(72) Inventors: Che-Yuan LIU, PA-TE CITY (TW); Yu OU-YANG, PA-TE CITY (TW)

(21) Appl. No.: 16/694,072

(22) Filed: Nov. 25, 2019

(51) Int. Cl. A41D 31/24; B32B 5/26

(52) U.S. Cl. CPC A41D 31/245; F41H 5/0485; B32B 5/26

(57) ABSTRACT

A puncture-proof structure of the present invention comprises at least two first fiber layers, an intermediate layer and at least two second fiber layers, which are stacked in sequence. A first fiber layers includes a plurality of first woven fibers having a plurality of first gaps therebetween. Another of the first fiber layers includes a plurality of first fibers, and the plurality of first fibers is arranged to be overlapped to enclose the plurality of first gaps. A second fiber layers includes a plurality of second woven fibers, and the plurality of second woven fibers having a plurality of second gaps therebetween. Another of the second fiber layers includes a plurality of second fibers, and the plurality of second fibers is arranged to be overlapped to enclose the plurality of second gaps. By such arrangement, the puncture-proof structure can achieve the effect of preventing the front and back from being punctured.

### FIELD OF THE INVENTION

The present invention is related to a puncture-proof structure, especially to a puncture-proof structure that can achieve the effect of preventing both the front and the back of the puncture-proof structure from being punctured.

### BACKGROUND OF THE INVENTION

Generally, protective clothing is mainly made up of plurality of fiber layers that is stacked, and thus has limited bulletproof effect, and because there are gaps between the fiber layers, it is possible for the protective clothing to be punctured by any sharp object, such as a bayonet and a fruit knife. The protective clothing with bulletproof effect is made of a ceramic plate and a bulletproof fiber barrier, thereby when a bullet pierces through the surface of the protective clothing, most of the energy of its penetrating force is removed through weakening, fixing, offsetting and absorbing effects provided by the ceramic plate and then the residual energy is buffered through the barrier layer, so as to produce the bullet-proof effect. Therefore, in order to effectively produce the bulletproof effect, it is necessary to have a sufficient thickness for the ceramic plate. However, if this kind of bulletproof clothing is used as puncture-proof protective clothing, the overall weight of this kind of protective clothing is increased, which is not suitable for ordinary people. Furthermore, the arrangements of the ceramic plate and the barrier layer are mainly designed for the situation in which the bullet is shot in the direction from the ceramic plate. In other words, if such structure installed in a backpack or a bag, or formed as a single protective plate, it is hard for users to distinguish whether the front and the back in an emergency. As a result, the protective effect cannot be effectively achieved.

### SUMMARY OF THE INVENTION

In view of this, in order to provide a structure that differs from the prior art and can improve the shortcomings mentioned above, Inventor has continuously researched and made improvements for many years, and developed the present invention.

One object of the present invention is to provide a puncture-proof structure by combining at least two first fiber layers and at least two second fiber layers respectively onto a front and back of an intermediate layer, and providing a plurality of first fibers of one first fiber layer to enclose a plurality of first gaps of another of the first fiber layer, and providing the plurality of second fibers of one second fiber layer to enclose the plurality of second gaps of another of the second fiber layer. Such arrangements can solve the problems that the conventional protective clothing cannot completely prevent itself from being punctured by any sharp object, such as a sharp knife, that the weight of the conventional protective clothing is too heavy, and that the front or back of the conventional protective clothing cannot be distinguished instantly, so as to effectively produce the puncture-proof effect, and reduce the overall weight to be convenient to carry on, and provide protection on both surfaces of the puncture-proof structure of the present invention in emergent or dangerous situation, so as to improve overall safety of the present invention.

In an implementation, the puncture-proof structure of the present invention comprises at least two first fiber layers, an intermediate layer and at least two second fiber layers, which are stacked in sequence. One of the at least two first fiber layers includes a plurality of first woven fibers having a plurality of first gaps therebetween. Another of the at least two first fiber layers includes a plurality of first fibers, and the plurality of first fibers is arranged to be overlapped to enclose the plurality of first gaps. One of the at least two second fiber layers includes a plurality of second woven fibers, and the plurality of second woven fibers having a plurality of second gaps therebetween. Another of at least two second fiber layers includes a plurality of second fibers, and the plurality of second fibers is arranged to be overlapped to enclose the plurality of second gaps.

In an implementation, the intermediate layer comprises a plurality of ceramic plates that is horizontally adjacent to each other, and the intermediate layer is a metal sheet.

In an implementation, the ceramic plate is a quadrilateral plate having four lateral parts, and each of which has an inclined plane that extends obliquely from a top surface of the ceramic plate toward a bottom surface of the ceramic plate.

In an implementation, the present invention further comprises a coating layer wrapping the outer surfaces of the intermediate layer. The coating layer wraps the outer surfaces of the at least two first fiber layers, the intermediate layer and the at least two second fiber layers.

In an implementation, each ceramic plate has a thickness between 3 and 10 mm.

In an implementation, the first woven fibers, the first fibers, the second woven fibers, and the second fibers are high elastic and tensile strength fibers.

The present invention will be understood more fully by reference to the detailed description of the drawings and the preferred embodiments below. In order to deeply understand the present invention, the embodiments of the present invention are described below.

### BRIEF DESCRIPTION OF DRAWINGS

FIG. 1 is a cross-sectional view showing a first embodiment of the present invention.

FIG. 2 is a view showing the use state of the first embodiment of the present invention.

FIG. 3 is a cross-sectional view showing a second embodiment of the present invention.

FIG. 4 is a cross-sectional view showing a third embodiment of the present invention.

FIGS. 5 and 6 are schematic views showing the three-dimensional appearance of the ceramic plate of the third embodiment of the present invention.

### DETAILED DESCRIPTIONS OF PREFERRED EMBODIMENTS

A puncture-proof structure of the present invention comprises at least two first fiber layers, an intermediate layer and at least two second fiber layers that are stacked and bonded in sequence. A plurality of first fibers of one first fiber layer is arranged to be overlapped with a plurality of first gaps of another of the first fiber layers to enclose the plurality of first gaps; a plurality of second fibers of one second fiber layer is arranged to overlapped with a plurality of second gaps of another of the second fiber layers to enclose the plurality of second gaps, so as to produce the effect of preventing of the front and back of the puncture-proof structure from being penetrated by any sharp object.

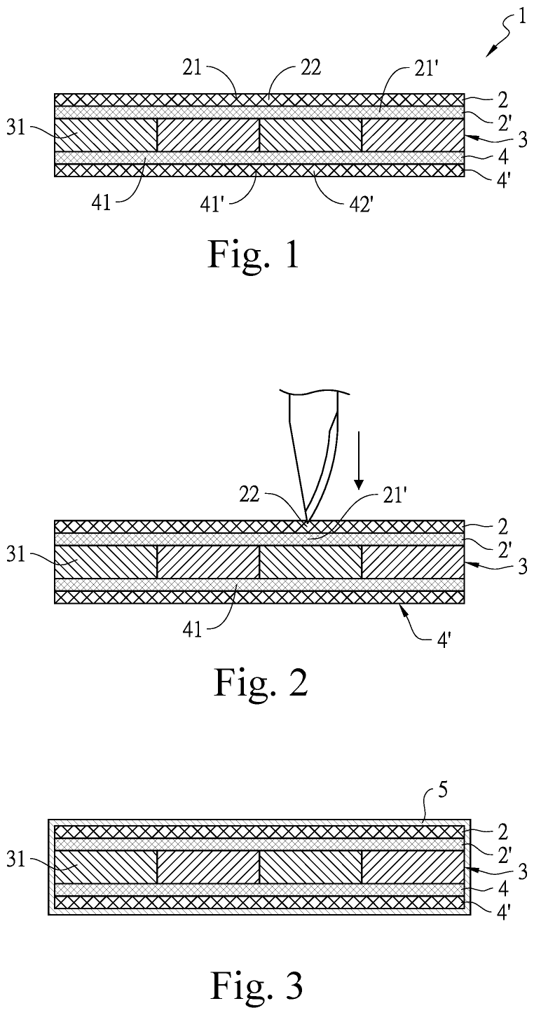

Please refer to FIG. 1, which shows a first embodiment of the puncture-proof structure 1 of the present invention and the puncture-proof structure 1 comprises two first fiber layers (2, 2′), an intermediate layer 3, and two second fiber layers (4, 4′) that are stacked in sequence. The first fiber layer 2 includes a plurality of first woven fibers 21, and the plurality of first woven fibers 21 has a plurality of first gaps 22 therebetween, and each first gap 22 is provided between any two adjacent first woven fibers 21. When the first fiber layer 2 is formed, the plurality of first gaps 22 is respectively filled with hardened resin. The first fiber layer 2′ is arranged to be overlapped and bonded to the bottom surface of the first fiber layer 2, and the first fiber layer 2′ includes a plurality of cross-woven first fibers 21′. In one embodiment, the first fiber layer 2′ may also include a plurality of first fibers 21′ arranged in parallel. A plurality of first fibers 21′ is located below the plurality of first gaps 22 to be overlapped with and enclose the plurality of first gaps 22. The first woven fibers 21 and the first fibers 21′ are respectively Kevlar fibers. In another embodiment, the first woven fibers 21 and the first fibers 21′ may respectively also be high elastic and tensile strength fibers, such as carbon fibers, glass fibers or an ultra high molecular weight polyethylene (UHWPE) fibers.

The intermediate layer 3 is arranged to be overlapped with and bonded to the bottom surface of the first fiber layer 2′, and the intermediate layer 3 includes a plurality of ceramic plates 31 that is arranged to be horizontally adjacent to each other. Each ceramic plate 31 has a thickness between 3 and 10 mm, and each ceramic plate 31 is a quadrilateral plate. In one embodiment, the intermediate layer 3 may also be a metal sheet having the same size and shape as the first fiber layer (2, 2′) and the second fiber layer (4, 4′).

The second fiber layer 4 is arranged to be overlapped with and bonded to the bottom surface of the intermediate layer 3. The second fiber layer 4 includes a plurality of second fibers 41 that is cross-woven. In one embodiment, the second fiber layer 4 may also include a plurality of second fibers 41 arranged in parallel. The second fiber layer 4′ is arranged to be overlapped and bonded to the bottom surface of the second fiber layer 4, and the second fiber layer 4′ includes a plurality of second woven fibers 41′ having plurality of second gaps 42′ therebetween. Each second gap 42′ is a gap between any two adjacent second woven fibers 41′. When the second fiber layer 4′ is formed, the plurality of second gaps 42′ is respectively filled with the hardened resin. The plurality of second fibers 41′ is positioned above the plurality of second gaps 42 to be overlapped with and enclose the plurality of second gaps 42′. The second woven fibers 41 and the second fibers 41′ are respectively Kevlar fibers. In another embodiment, the second woven fiber 41 and the second fiber 41′ may also respectively be high elastic and tensile strength fibers, such as carbon fibers, glass fibers or ultra high molecular weight polyethylene (UHWPE) fibers.

Thereby, as shown in FIG. 2, when the first fiber layer 2 of the front of the present invention is punctured by any sharp object, such as a bayonet or a fruit knife, if it passes through the first gaps 22, it would be blocked by the first fiber 21′ of the first fiber layer 2′ together with the intermediate layer 3, so that any sharp object cannot penetrate it, and thus produce the puncture-proof effect. Since the ceramic plates 31 of the intermediate layer 3 can be made thinner, the weight of the overall structure of the present invention can be reduced to be convenient to carry on. Further, since the second fiber layer 4′ on the back of the puncture-proof structure 1 can also provide blocking effect produced by the second fibers 41 and the intermediate layer 3, the safety for users can be more effectively secured in a dangerous situation.

Please refer to FIG. 3, which shows a second embodiment of the puncture-proof structure 1 of the present invention, and it is different from the first embodiment in that, a fiber cloth is completely wrapped on outer surfaces of the two first fiber layers. (2, 2′), an intermediate layer 3 and two second fiber layers (4, 4′). The fiber cloth is used as a coating layer 5, so as to wrap and position the intermediate layer 3 to prevent the adjacent ceramic plates 31 of the intermediate layer 3 from being separated from each other. In another embodiment, the coating layer 5 can be also directly wrapped on the outer surfaces of the intermediate layer 3, so as to produce the effect of preventing the adjacent ceramic plates 31 from being separated from each other.

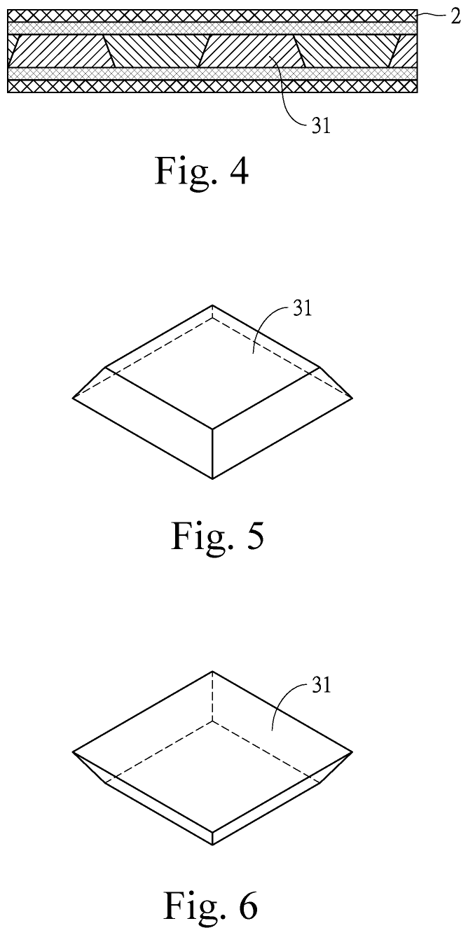

Please refer to FIGS. 4-6, which show a third embodiment of the puncture-proof structure 1 of the present invention, and it is different from the first embodiment in that, the four lateral parts of the ceramic plate 31 respectively has an inclined plane that extends obliquely from a surface of the ceramic plate 31 toward another surface of the ceramic plate 31. Thereby, when the adjacent ceramic plates 31 are arranged in the reverse direction, the adjacent inclined planes may be in contact with each other, so as to form overlapped regions between the adjacent ceramic plates 31 to prevent the puncture-proof structure 1 from being punctured by any sharp object, and thus to enhance the protective effect.

To sum up, the present invention can indeed meet its anticipated objects and provide a safe puncture-proof structure that is light to be installed in a backpack or a leather bag to easily carry and is convenient for users to use both the front and the back of the puncture-proof structure without distinction, so as to produce protective effect in any dangerous situation, and can be put into industrial use.

What is claimed is:

1. An puncture-proof structure, comprising at least two first fiber layers, an intermediate layer and at least two second fiber layers, which are stacked in sequence, wherein one of the at least two first fiber layers includes a plurality of first woven fibers having a plurality of first gaps therebetween; another of the at least two first fiber layers includes a plurality of first fibers, and the plurality of first fibers is arranged to be overlapped to enclose the plurality of first gaps; and
one of the at least two second fiber layers includes a plurality of second woven fibers, the plurality of second woven fibers having a plurality of second gaps therebetween; another of at least two second fiber layers including a plurality of second fibers, and the plurality of second fibers is arranged to be overlapped to enclose the plurality of second gaps.

2. The puncture-proof structure according to claim 1, wherein the intermediate layer comprises a plurality of ceramic plates that is horizontally adjacent to each other.

3. The puncture-proof structure according to claim 2, further comprising a coating layer wrapping the outer surfaces of the intermediate layer.

4. The puncture-proof structure according to claim 2, wherein each ceramic plate has a thickness between 3 and 10 mm.

5. The puncture-proof structure according to claim 1, wherein the ceramic plate is a quadrilateral plate having four lateral parts, and each of which has an inclined plane that extends obliquely from a top surface of the ceramic plate toward a bottom surface of the ceramic plate.

6. The puncture-proof structure according to claim 5, further comprising a coating layer wrapping the outer surfaces of the intermediate layer.

7. The puncture-proof structure according to claim 5, wherein each ceramic plate has a thickness between 3 and 10 mm.

8. The puncture-proof structure according to claim 1, wherein the intermediate layer is a metal sheet.

9. The puncture-proof structure according to claim 1, further comprising a coating layer wrapping the outer surfaces of the at least two first fiber layers, the intermediate layer and the at least two second fiber layers.

10. The puncture-proof structure according to claim 1, wherein the first woven fibers, the first fibers, the second woven fibers, and the second fibers are high elastic and tensile strength fibers.
